(19) United States
(12) Patent Application Publication
(10) Pub. No.: US 2025/0053521 A1
(43) Pub. Date: Feb. 13, 2025

(54) CONTEXT-BASED COMPRESSION IN A MEMORY SYSTEM

(71) Applicant: Rambus Inc., San Jose, CA (US)

(72) Inventor: Evan Lawrence Erickson, Chapel Hill, NC (US)

(21) Appl. No.: 18/786,296

(22) Filed: Jul. 26, 2024

Related U.S. Application Data
(60) Provisional application No. 63/518,534, filed on Aug. 9, 2023.

(51) Int. Cl. G06F 13/16; G06F 12/02; G06F 13/42

(52) U.S. Cl. CPC G06F 13/1673; G06F 12/0292; G06F 13/4282

(57) ABSTRACT

A memory system selectively compresses and/or decompresses pages of a memory array based on requests from a host device. Upon performing compression, the memory buffer device returns compression context metadata to the host device for storing in the page table of the host device to enable the host device to subsequently obtain data from the compressed page. The host device may subsequently send a request for the memory buffer device to perform decompression to a free page in the memory array for accessing by the host device, or the host device may directly access the compressed page for local decompression and storage.

### CROSS-REFERENCE TO RELATED APPLICATIONS

This application claims the benefit of U.S. Provisional Patent Application No. 63/518,534 filed on Aug. 9, 2023, which is incorporated by reference herein.

### BACKGROUND

In a memory system, a host facilitates read and write operations associated with one or more memory devices. Because memory capacity may be limited, a memory system may compress select pages of memory and/or designate regions of disk storage for virtual memory. However, use of disk storage and compressed pages may implicate tradeoffs in read/write latency of memory operations.

### BRIEF DESCRIPTION OF THE DRAWINGS

The teachings of the embodiments herein can be readily understood by considering the following detailed description in conjunction with the accompanying drawings.

FIG. 1 is a block diagram illustrating an example embodiment of a memory system.

FIG. 2 is a flowchart illustrating an example embodiment of a process for managing a memory operation associated with a virtual memory address in a host device.

FIG. 3 is a flowchart illustrating an example embodiment of a process for managing a compression request in association with virtual memory management.

FIG. 4 is a flowchart illustrating an example embodiment of a process for managing compression by a host device in association with virtual memory management.

FIG. 5 is a flowchart illustrating an example embodiment of a process for managing a decompression request in association with virtual memory management.

FIG. 6 is a flowchart illustrating an example embodiment of a process for managing a request for a compressed page in association with virtual memory management.

### DETAILED DESCRIPTION

A memory system selectively compresses and/or decompresses pages of a memory array based on requests from a host device. The host device determines pages of the memory to compress or decompress and tracks the physical addresses of compressed, uncompressed, and free pages in a page table. To compress a page, the host device sends a request to a memory buffer device that performs the compression and returns compression context metadata for storing in the page table that enables the host device to subsequently obtain data from the compressed page. Alternatively, the host device may perform compression and facilitate writing of the compressed page to the memory array via the memory buffer device. The host device may subsequently send a request to the memory buffer device based on the compression context metadata. The memory buffer device may perform decompression to a free page in the memory array to enable access by the host device. Alternatively, the host device may directly access the compressed page and perform local decompression.

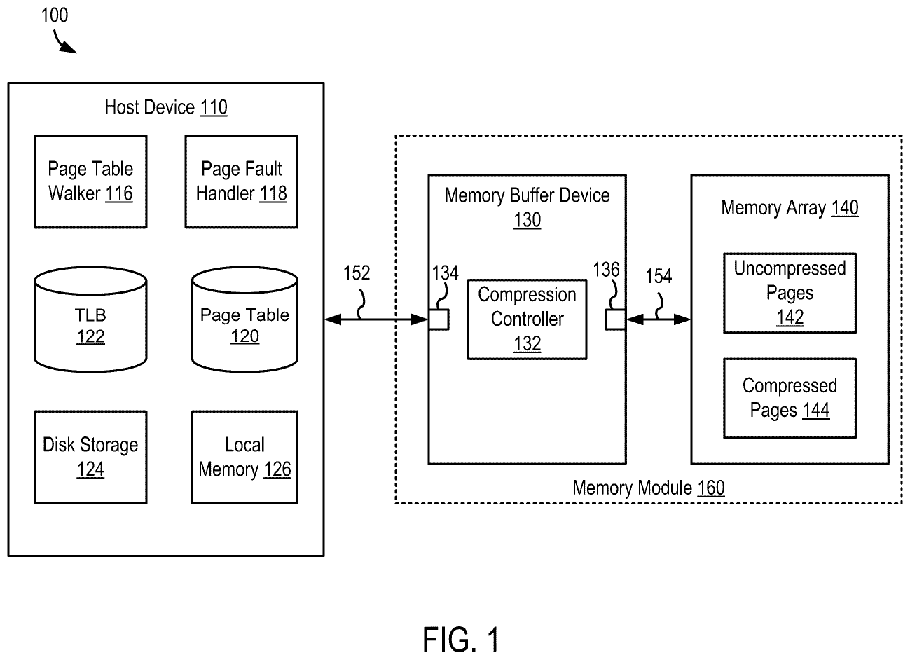

FIG. 1 illustrates an embodiment of a memory system 100 comprising a host device 110, a memory buffer device 130, and a memory array 140. The host device 110 communicates with the memory buffer device 130 over a communication link 152 for facilitating various memory operations of the memory array 140. The memory buffer device 130 facilitates memory operations of the memory array 140 via the communication link 154. The communication link 154 may a comprise standard memory control interface such a command/address interface (CA), data interface (DQ), and various interfaces associated with control and timing signals. The memory buffer device 130 and the memory array 140 may be integrated in a memory module 160, which may comprise separate integrated circuits on a printed circuit board or may comprise a single integrated circuit chip. Although FIG. 1 illustrates only a single memory buffer device 130 and memory array 140, various embodiments may include a memory module 160 that includes more than one memory buffer device 130 coupled to a single host device 110 and/or may include multiple memory arrays 140 that interoperate with one or more memory buffer devices 130. Furthermore, in some embodiments, multiple host devices 110 may be coupled to a memory module 160 via shared or separate communication links 152.

In an embodiment, the memory system 100 comprises a serial-attached memory system in which the communication link 152 between the host device 110 and the memory buffer device 130 comprises a serial link that communicates serialized packetized commands and data. For example, the communication link 152 may comprise a Compute Express Link (CXL) interface, an Open Memory Interface (OMI), a Coherent Accelerator Processor Interface (CAPI), a Peripheral Component Interconnect Express (PCIe) interface, or other interfaces. The memory buffer device 130 and the memory array 140 may be embodied in a serial-attached memory module 160, such as a CXL module. In these embodiments, the memory buffer device 130 may include logic for converting between the serialized communication protocol of the communication link 154 and the memory control/data communication protocol of communication link 152.

In another embodiment, the communication link 152 may comprise a double data rate (DDR) DRAM communication link or other memory controller link having a similar interface to the communication link 154. In this embodiment, the host device 110 may comprise a memory controller and the memory for communicating between a locally connected host device 110 (such as a memory controller) and a memory buffer device 130. In this embodiment, the memory buffer device 130 and memory array 140 may be integrated into a memory device chip. memory module 160. In some embodiments, the host device 110, memory buffer device 130, and memory array 140 may reside on the same printed circuit board. In a local memory system, the host device 110 may control multiple memory buffer devices 130 and/or memory arrays 140 that may be embodied in one or more memory modules 160 (e.g., a dual-inline memory module (DIMM)).

The memory array 140 may comprise a DRAM (or a set of DRAMs) that communicates with the memory buffer device 130 over one or more communication links 154 such as a command/address (CA) link and a data (DQ) link, and other ports associated with timing and configuration signals. In a memory write operation, the memory array 140 receives a memory write command including a memory address and receives write data over the communication link 154. The memory array 140 stores the received write data to the memory address specified in the memory write command. In a memory read operation, the memory array 140 receives a read command including a memory address, and outputs read data stored at the memory address over the communication link 154. The memory array 140 may furthermore perform other operations responsive to received commands such as refresh operations, precharge operations, mode register read and write operations, and other memory operations.

As will be described further below, data in the memory array 140 may be organized into pages comprising fixed-sized blocks identifiable by a physical address corresponding to the start of the page. At least a subset of pages in the memory array 140 may be stored as compressed pages 144 while remaining pages are stored as uncompressed pages 142. Compressed pages 144 take up a smaller region of memory relative to uncompressed pages 142. For example, if memory is compressed 2:1, two compressed pages 144 may be stored in the same size memory space as a single uncompressed page 142. Regions of the memory array 140 may be reserved for compressed pages 144 (e.g., a predefined range of physical addresses), or regions of the memory array 140 may be dynamically assigned for storing compressed pages 144 or uncompressed pages 142, as will be further described below.

The memory buffer device 130 includes a host-side interface 134, a compression controller 132, and a memory-side interface 136. The host-side interface 134 comprises one or more ports for communicating commands, command responses, and data between the host device 110 and the memory buffer device 130. In a CXL-based system, the host-side interface 134 may packetize outgoing signals for sending to the host device 110 and depacketize incoming signals received from the host device 110. In a local memory system, the host-side interface 134 may comprise a set of ports for communicating with a memory controller such as a CA port, DQ port, and various timing/control ports.

The memory-side interface 136 comprises a set of ports for communicating with the memory array 140. For example, the memory-side interface 136 may include at least a CA port for communicating memory write and memory read commands to the memory array 140, a DQ port for communicating write data and read data, and various timing/control ports.

The compression controller 132 performs compression and/or decompression of data stored to memory array 140 in response to requests from the host device 110. When performing compression, the compression controller 132 may furthermore generate compression context metadata for sending to the host device 110 and/or storing to the memory array 140 that provides information sufficient to enable the host device 110 to subsequently obtain data from the compressed page, either by directly accessing the compressed page or by requesting that the memory buffer device 130 decompress the page and subsequently accessing the decompressed page. For example, the compression context metadata may comprise a pointer to the physical address associated with the compressed pages 144. The compression context metadata may furthermore include various decompression parameters such as a data size of the compressed page, a compression scheme, or various other information about the compressed page 144. In other embodiments, the compression controller 132 may instead receive the compression context metadata from the host device 110 in association with a page compressed by the host device 110. Here, the compression controller 132 may select a physical address for storing the compressed page and the associated compression context metadata and facilitate write operations. Example compression and decompression operations of the memory buffer device 130 are described in further detail below.

The host device 110 may include local disk storage 124, local memory 126, and various memory management components including a page table 120, a translation lookaside buffer (TLB) 122, a page table walker 116, and a page fault handler 118. These host device 110 may facilitate a virtual memory addressing technique in which each process executed by the host device 110 is assigned its own virtual memory space abstracted from physical memory locations. Each virtual memory address of a process may be dynamically mapped to a corresponding physical address and associated page of data. Each virtual memory address may correspond to a physical memory address in the memory array 140, in the local memory 126 of the host device 110, or in disk storage 124 of the host device 110.

Read and write operations associated with accesses to the memory array 140 or local memory 126 generally have significantly lower latency than accesses to the disk storage 124. Therefore, the host device 110 may manage virtual memory in a manner that generally utilizes the memory array 140 (or local memory 126) for frequently accessed pages while reserving disk storage 124 for less frequently accessed pages and when memory capacity is limited. In order to enable increased capacity of the memory array 140 and reduce frequency of high latency accesses to disk storage 124, the host device 110 may furthermore selectively designate a subset of pages to be stored as compressed pages 144. Although accesses to compressed pages 144 have increased latency relative to accesses to uncompressed pages 142 (due to latency associated with compression and/or decompression), accesses to the compressed pages 144 are still generally lower latency than accesses to disk storage 124.

The translations between the virtual memory addresses and physical memory addresses are stored as respective page table entries in the page table 120 of the host device 110. The page table 120 may additionally store other information such as physical addresses of free pages and various metadata. For compressed pages 144, the page table entry may include the compression context metadata that indicates that the page is not present as an uncompressed page 142 and specifies a physical address of the compressed page 144. The compression context metadata may optionally include additional information useful for decompression such as a size of the compressed page, a compression scheme, etc.

The TLB 122 comprises a memory cache that stores a subset of page table entries from the page table. Lookups in the TLB 122 are typically faster than lookups in the page table 120, and it is therefore beneficial to manage the TLB 122 to minimize lookups in the page table 120. For example, in one management approach, the TLB 122 may store a fixed number of most recently accessed page table entries since these entries may be more likely to be accessed again.

The page table walker 116 performs the virtual address lookups in the TLB 122 and the page table 120. The page table walker 116 may furthermore manage updates to TLB 122 and may perform various other functions such as triggering decompression of a compressed page.

The page fault handler 118 executes (e.g., as an interrupt request) when a translation of a virtual memory address to a physical memory address is not present in the TLB 122. This situation, referred to as a page fault, may occur when the data associated with the virtual memory address is stored as a compressed page 144 or in response to various other conditions. For page faults associated with compressed pages 144, the page fault handler 118 allocates a free page to be used for decompression, requests decompression of the compressed page 144 (based on the compression context metadata) to the free page, updates the page table entry in the page table 120 with the address of the free page, and updates the TLB 122 to map the virtual address to the physical address of the decompressed memory location. In some instances, allocating the free page may comprise swapping the compressed page 144 which a selected uncompressed page 142, i.e., the requested compressed page 144 is decompressed and a different uncompressed page 142 is selected and compressed in its place. Allocating the free page may furthermore comprise moving a page from the memory array 140 to disk storage 124. In other instances, if free pages are already available, the compressed page 144 may be decompressed to the free page location, without necessarily compressing a different page. In other instances, where the compressed page 144 occupies only a portion of a region of otherwise free memory, the compressed page 144 may be decompressed to the same physical address.

Compression and decompression requests may be sent from the host device 110 to the memory buffer device 130 during execution of the page fault handler 118 using either in-band vendor-defined messages (e.g., using CXL.io or Data Object exchange (DOE) formats) or out-of-band using communication interfaces such as SMBus, I3c, etc. Example processes associated with facilitating compression and decompression in a memory buffer device 130 for virtual memory management are described in further detail below.

Various components of the host device 110 may be implemented in hardware (e.g., using digital logic circuits), firmware, and/or software (e.g., as functions of a CPU, a memory management module, and/or an operating system executing on the host device 110). For software functions, a CPU of the host device may execute instructions stored to a non-transitory computer-readable storage medium. Functions of the compression controller 132 of the memory buffer device 130 may similarly be implemented in hardware (e.g., using digital logic circuits), firmware, software (e.g., based on instructions stored to a non-transitory computer-readable storage mediums and executed by a processor), or any combination thereof.

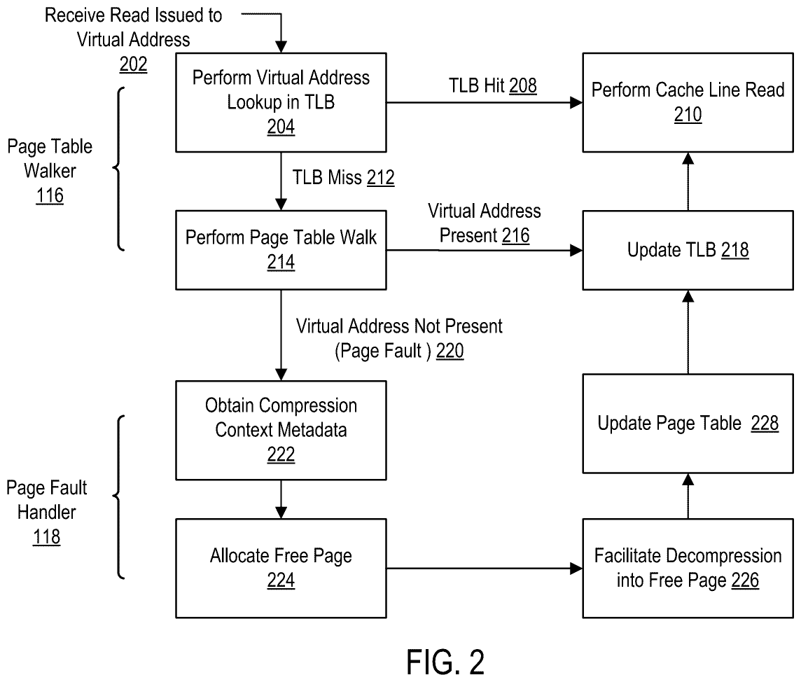

FIG. 2 illustrates an example embodiment of a process for managing a memory operation associated with a virtual memory address. The page table walker 116 receives 202 a read request associated with a virtual address, and performs 204 a lookup of the virtual address in the TLB 122. If the virtual address is present in the TLB 122 (i.e., a hit 208), the host device 110 performs 210 a cache line read from the physical memory address corresponding to the virtual address specified in the TLB 122. Otherwise, if the virtual address is not present in the TLB 122 (i.e., a miss 212), the page table walker 116 performs 214 a page table walk of the page table 120 to determine if the virtual address is present as an uncompressed page 142, whether it is stored as a compressed page 144, or whether it is in disk storage 124. In an example implementation, the page table 120 may store a present bit in the page table entry associated with the virtual address that indicates whether the corresponding page is present or absent in the memory array 140 as an uncompressed page 142 (e.g., present bit=1 when present, present bit=0 when absent). The page table entry may furthermore store a compression bit to indicate whether an absent page is stored as a compressed page 144 (or otherwise, may be stored in disk storage 124). If the page table 120 indicates that the page associated with the virtual address is present as an uncompressed page 142, the page table walker 116 updates 218 the TLB 122 with the physical address specified in the page table entry of the page table 120 and performs 210 the cache line read associated with the physical address. If the page table 120 instead indicates that the virtual address is not present as an uncompressed page 142, a page fault is issued for handling by the page fault handler 118. The page fault handler 118 determines (e.g., based on the compression bit) if the requested page is stored as a compressed page 142 and if so, obtains 222 compression context metadata associated with the page table entry for the virtual address. The page fault handler 118 allocates 224 a free page for storing the page upon decompression. The allocated free page may be either in the memory array 140 (either at the same physical address as the compressed page 144 or a different physical address) or may correspond to a page in local memory 126. Here, allocating 224 the free page may involve selecting an uncompressed page 142 to be compressed and facilitating compression of the selected page (thus swapping the uncompressed page 142 for the requested page). The page fault handler 118 furthermore facilitates 226 decompression of the compressed page. As will be described in further detail below, the page fault handler 118 may either send a request to the memory buffer device 130 for the memory buffer device 130 to decompress the compressed page 142, or the page fault handler 118 may directly access the compressed page 144 and the host device 110 may perform the decompression. The page fault handler 118 furthermore updates 228 the page table entry with the physical address of the decompressed page and marks the virtual address as present in the page table entry (e.g., by setting a present bit). The page table walker 116 may then update 218 the TLB 122 from the page table entry and perform 210 the cache line read in the same manner described above. If upon execution of the page fault handler 118, the requested page is instead stored to disk storage 124, the page fault handler 118 may instead move the page from disk storage 124 to the memory array 140 or the local memory 126, and then proceed to update 228 the page table as described above (skipping steps 222, 224, 226).

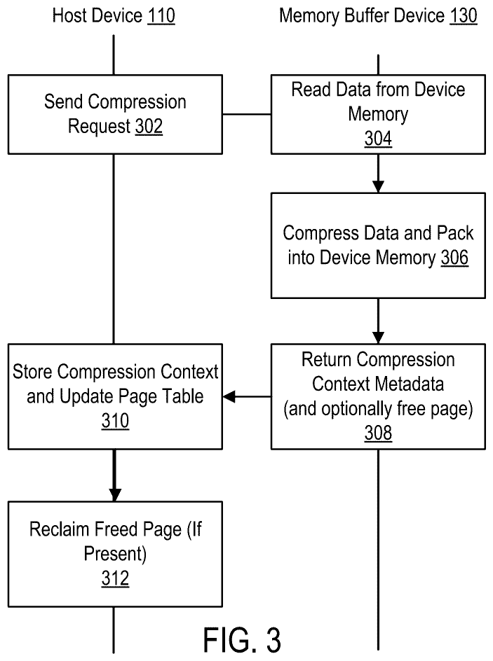

FIG. 3 illustrates an example embodiment of a process for managing a compression request in the context of a virtual memory system. The host device 110 determines to compress a page of memory in the memory array 140 and sends 302 a compression request to the memory buffer device 130. The compression request may specify the physical address of the page to be compressed, a minimum compression ratio, and other parameters for facilitating compression of the page. In an embodiment, the memory buffer device 130 is responsible for determining a physical memory address for storing the compressed page. Here, the physical address may be the same address as the uncompressed page or may be a memory address associated with a free page or portion of a freed page sufficient for the compressed page size. For example, if 2:1 compression is performed, two compressed pages may be packed into the same memory space previously occupied by a single uncompressed page. In another embodiment, the physical address for the compressed page may be determined by the host device 110 and sent with the compression request. The memory buffer device 130 reads 304 the page data from the memory array 140 from the physical address specified in the memory request. The memory buffer device 130 then compresses 306 the page data and stores the compressed page to the memory array 140 at the selected physical address. The memory buffer device 130 furthermore returns 308 at least a subset of the compression context metadata to the host device 110 that includes information sufficient to enable the host device 110 to subsequently request decompression of the compressed page or directly access the compressed page. For example, the compression context metadata may include at least a pointer to the physical address of the compressed page and may include compression information such as the size of the compressed page (e.g., in number of 1 KiB slots or the total size in bytes), sub-page indexes, dictionary identifiers, or other parameters. The compression context metadata may furthermore include error information, if any, to indicate if the page failed to compress or other error conditions. If compression results in a page (or portion of a page) being newly freed, the memory buffer device 130 may furthermore send identifying information to the host device 110 indicative of the freed page. For example, if 2:1 compression is performed, two pages of uncompressed may be compressed into a single compressed page, thereby freeing additional page. The host device 110 receives 312 and stores the compression context metadata to the relevant page table entry. For example, the host device 110 may store an indication that the page is compressed and store the compression context metadata in association with the virtual address corresponding to the compressed page. For example, the host device 110 may reset the present bit and set a compression bit in the page table entry. If applicable, the host device 110 may furthermore update its free page list to track the physical address of one or more freed pages resulting from the operation.

In one implementation, the full compression context metadata is sent and stored to the relevant page table entry of the host device 110. In another implementation, only a portion of the compression context metadata is sent to the host device 110 and stored to the page table entry. For example, the memory buffer device 130 may send only a pointer to a physical address of the compressed page to the host device 110. In this case, remaining compression context metadata may be stored in uncompressed form in the memory array 140 or memory buffer device 130 in association with the physical address of the compressed page. For example, the remaining compression context metadata may be stored in uncompressed form preceding the first compressed cache line at the specified physical address. Alternatively, the compression context metadata be stored in a device-side page table and retrieved by the memory buffer device 130 upon receiving a request to decompress the compressed page.

In some operations, the compression request may relate to a page stored in a device-side cache of the memory buffer device 130. For example, a page may be written from the host device 110 to the device-side cache, compressed by the memory buffer device 130, and written in compressed form to the memory array 140.

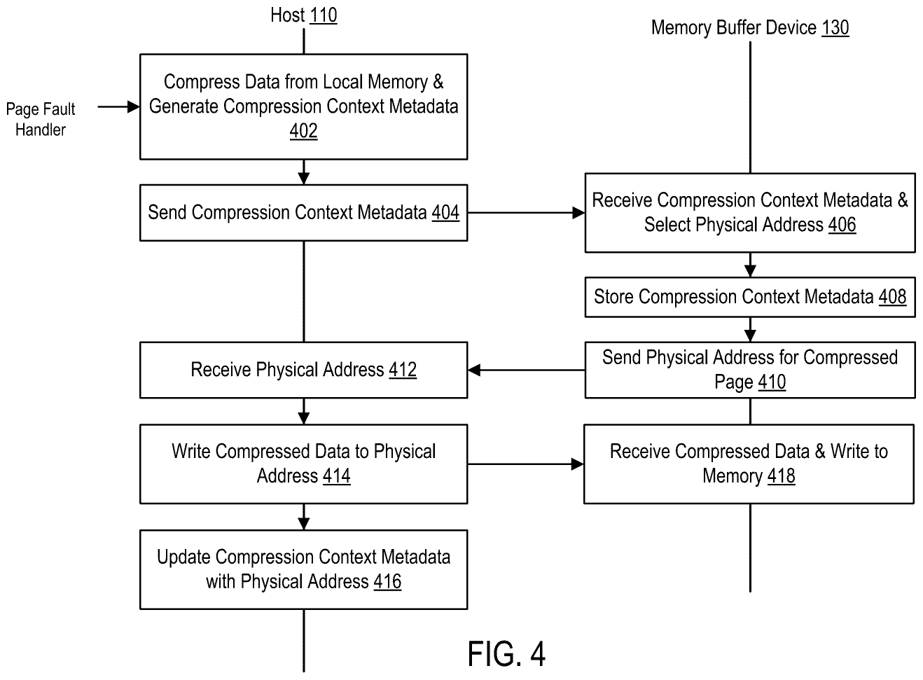

FIG. 4 illustrates another example embodiment of a process for managing page compression in the context of a virtual memory system. In this example embodiment, compression is instead performed by the host device 110 and sent to the memory buffer device 130 in compressed form for storage in the memory array 140. In an example process, the host device 110 compresses 402 a page from its local memory 126 and generates the corresponding compression context metadata. The host device 110 then sends 404 the compression context metadata to the memory buffer device 130. The memory buffer device 130 receives 406 the compression context metadata and selects a physical address in the memory array 140 for storing the compressed page. The memory buffer device 130 locally stores 408 the compression context metadata and sends 410 the physical address for the compressed page to the host device 110. The compression context metadata may be stored in a device-side page table, to a specific location in the memory array 140, or to another storage location. The host device 110 receives 412 the physical address and issues commands to write 414 the compressed data to the specified physical address. The host device 110 furthermore updates 416 the compression context metadata stored by the host device 110 (e.g., in the page table entry) to include the specified physical address. The memory buffer device 130 receives 418 the compressed page from the host device 110 and writes it to the memory array 140. This step may be performed before, after, or in parallel with the host device 110 updating 110 the compression context metadata.

In an embodiment, the host device 110 may determine whether to handle compression according to process of FIG. 3 (in which the host device 110 instructs the memory buffer device 130 to compress the page to the memory array 140) or according to the process of FIG. 4 (in which the host device 110 performs the compression).

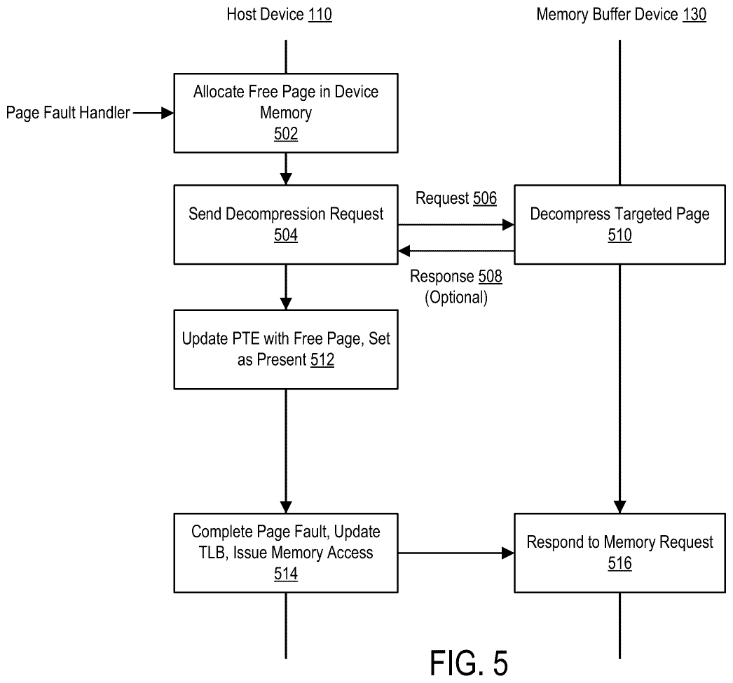

FIG. 5 illustrates a first example embodiment of a process for handling a page fault triggered when a lookup of a virtual address in the page table indicates that the page is in compressed memory (i.e., when the present bit is not set and a compression bit is set). The host device 110 allocates 502 a free page of the memory array 140 for storing the decompressed page upon decompression. The physical address for the free page may be selected from the set of free pages tracked by the host device 110. Alternatively, the host device 110 may select an uncompressed page for compression and compress the page to free up a physical address for allocation. The host device 110 sends 504 a decompression request 506 to the memory buffer device 130 identifying the physical address of the compressed page and the physical address of the allocated free page. If the page table entry of the host device 110 stores the full compression context metadata, the host device 110 may send the full compression context metadata to the memory buffer device 130. The memory buffer device 130 then performs decompression based on the compression context metadata. Alternatively, if only a portion of the compression context metadata is stored to the page table entry of the host device 110, the memory buffer device 130 may retrieve the remaining compression context metadata (which may be stored in uncompressed form preceding the first compressed cache line of the specified physical address, in a separate device-side page table, or other storage location), and utilize the compression context metadata to perform decompression. The memory buffer device 130 decompresses 510 the compressed page to the allocated region of the memory array 140. Optionally, the memory buffer device 130 may send a response 508 to the host device indicating acknowledgement of the request and/or any error information. The response 508 may be sent prior to completing decompression (e.g., immediately before or after the first cache line is decompressed). After receiving the response 508 (or if no response is used, after sending 504 the decompression request), the host device 110 updates 512 the page table entry to associate the virtual address with the allocated free page and sets the virtual address to present (e.g., by setting the present bit). The host device 110 may furthermore perform other steps to complete 514 the page fault such as updating the TLB 122 and issuing a memory access request to the memory buffer device 130 specifying the physical address of the decompressed page. Upon receiving the memory access request, the memory buffer device 130 responds 516 to the memory access. In an embodiment, the steps of updating 512 the page table entry and completing 514 the page fault may at least partially be performed in parallel with the memory buffer device 130 performing the decompression 510. Furthermore, the memory buffer device 130 may respond 516 to the memory access from the host device 110 after decompression 510 is completed, or while decompression is still being performed.

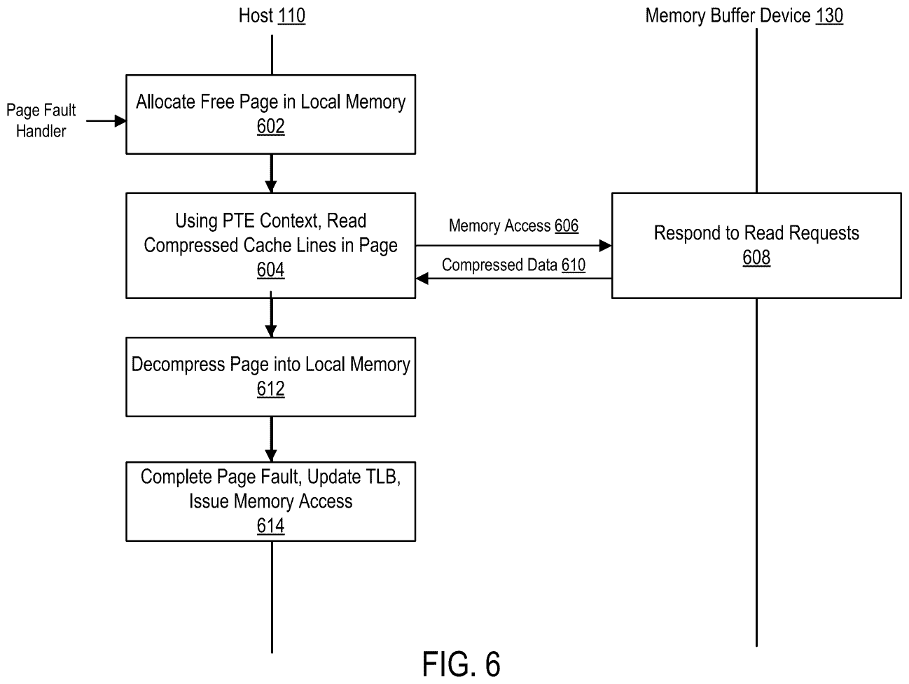

FIG. 6 illustrates another example of a process for handling a page fault triggered when a lookup of a virtual address in the page table indicates that the page is compressed in memory (e.g., when the present bit is not set and the compression bit is set). The host device 110 allocates 602 a free page in local memory 126 for storing the decompressed page. Using the compression context metadata in the page table entry, the host device 110 issues memory accesses 606 to the memory buffer device 130 to read 604 the compressed data 610. The memory buffer device 130 controls the memory array 140 to perform the read operations and responds 608 to the read requests with the compressed data 610 (i.e., without performing decompression on the memory buffer device 130). The host device 110 decompresses 612 the compressed page into the allocated free page of the local memory 126. The host device 110 completes 614 the page fault by updating the TLB 122 and issuing a memory access corresponding to the physical address of the decompressed page in the local memory 126. Completing 614 the page fault may optionally include indicating to the memory buffer device 130 that the page can be freed to enable the memory buffer device 130 to reclaim the memory region occupied by the page and update device-side address translation.

In different operations, the host device 110 may determine whether to request at least partial preservation of the compressed page when requesting decompression (e.g., via the process of FIG. 5) or accessing the compressed data (e.g., via the process of FIG. 6). Preserving the compressed page at least temporarily may enable the memory buffer device 130 to rapidly respond to a subsequent recompression request. For example, upon receiving a request to decompress a page while preserving the compressed page, the memory buffer device 130 may decompress the page into a device-side cache and track correspondence of the physical addresses associated with data in the decompressed page and the compressed page. The host device 110 may then request recompression of the page (which may include re-sending the compression context metadata). The memory buffer device 130 may determine whether the previously compressed version can be used (e.g., if the corresponding data in the device-side cache is unchanged) and respond to the request to enable the host device 110 to update its page table entry. If data lines in the device-side cache are changed, the memory buffer device 130 may selectively re-compress these lines without necessarily recompressing the entire page.

In an embodiment, the host device 110 may determine whether to handle a page fault according to process of FIG. 5 (in which the host device 110 instructs the memory buffer device 130 to decompress the page to the memory array 140) or according to the process of FIG. 6 (in which the host device 110 requests that the memory buffer device 130 provide the compressed page to the host device 110 for local decompression).

Upon reading this disclosure, those of ordinary skill in the art will appreciate still alternative structural and functional designs and processes for the described embodiments, through the disclosed principles of the present disclosure. Thus, while particular embodiments and applications of the present disclosure have been illustrated and described, it is to be understood that the disclosure is not limited to the precise construction and components disclosed herein. Various modifications, changes and variations which will be apparent to those skilled in the art may be made in the arrangement, operation and details of the method and apparatus of the present disclosure herein without departing from the scope of the disclosure as defined in the appended claims.

What is claimed is:

1. A memory buffer device comprising:
a host-side interface to receive a request from a host device to compress a selected page into a compressed page, and to send at least a subset of compression context metadata to the host device that enables the host device to subsequently obtain data from the compressed page;
a memory-side interface to communicate with a memory array; and
a compression controller to determine an address in the memory array for storing the compressed page, to perform compression of the selected page, to facilitate memory operations via the memory-side interface to store the compressed page to the address in the memory array, and to generate the compression context metadata.

2. The memory buffer device of claim 1, wherein the host-side interface further receives a request from the host device referencing the compressed page, and wherein the compression controller is further configured to facilitate access to the data from the compressed page responsive to the request.

3. The memory buffer device of claim 2, wherein the compression controller decompresses the compressed page based on the compression context metadata to generate a decompressed page, and enables the host device to access the decompressed page via the host-side interface.

4. The memory buffer device of claim 2, wherein the compression controller is further configured to receive a memory access from the host device for compressed data of the compressed page and to send the compressed data to the host device via the host-side interface responsive to the memory access.

5. The memory buffer device of claim 1, wherein the compression context metadata includes a pointer to the compressed page and one or more decompression parameters, and wherein the compression controller stores the one or more decompression parameters in uncompressed form at a physical address of the memory array associated with the compressed page, and wherein the compression controller sends the pointer to the host device via the host-side interface.

6. The memory buffer device of claim 5, wherein the host-side interface further receives a request from the host device to decompress the compressed page, wherein the request includes the pointer to the compressed page, and wherein the compression controller is further configured to retrieve the one or more decompression parameters in response to the request.

7. The memory buffer device of claim 1, wherein the memory buffer device is integrated in a serial-attached memory module and wherein the host-side interface comprises a serial communication link.

8. A method for managing a compression and decompression of data in a memory array, the method comprising:
receiving, at a host-side interface of a memory buffer device, a request from a host device to compress a selected page into a compressed page;
determining, by the memory buffer device, an address in the memory array for storing the compressed page;
performing, by the memory buffer device, compression of the selected page;
facilitating, by the memory buffer device, one or more memory operations to store the compressed page to the address in the memory array;
generating, by the memory buffer device, compression context metadata that enables the host device to subsequently obtain data from the compressed page; and
sending at least a subset of the compression context metadata to the host device via the host-side interface of the memory buffer device.

9. The method of claim 8, further comprising:
receiving, at the host-side interface of the memory buffer device, a request from the host device to decompress the compressed page;
decompressing the compressed page based on the compression context metadata to generate a decompressed page accessible to the host device via the host-side interface.

10. The method of claim 8, further comprising:
receiving, at the host-side interface, a memory access from the host device for compressed data in the compressed page; and
sending the compressed data to the host device via the host-side interface responsive to the memory access.

11. The method of claim 8, wherein the compression context metadata includes a pointer to the compressed page and one or more decompression parameters, and wherein sending at least the subset of the compression context metadata to the host device comprises:
storing, the decompression parameters in uncompressed form at a physical address of the memory array associated with the compressed page; and
sending the pointer to the host device via the host-side interface.

12. The method of claim 11, further comprising:
receiving, at the host-side interface, a request from the host device to access the compressed page, the request including the pointer to the compressed page; and
retrieving the one or more decompression parameters in response to the request; and
decompressing the page to a physical address of the memory array based on the decompression parameters.

13. The method of claim 11, wherein the memory buffer device is integrated in a serial-attached memory module and wherein the host-side interface comprises a serial communication link.

14. A method for operating a host device, comprising:
selecting a page of a memory array for compression;
sending a compression request to a memory buffer device to cause the memory buffer device to compress the page into a compressed page and store the compressed page in the memory array;
obtaining, from the memory buffer device, compression context metadata associated with the compressed page that enables the host device to subsequently obtain data from the compressed page; and
storing the compression context metadata to a page table of the host device.

15. The method of claim 14, further comprising:
obtaining a memory access request associated with a virtual address;
identifying a physical address of the compressed page associated with the virtual address; and
executing a page fault handler to facilitate decompression of the compressed page.

16. The method of claim 15, wherein executing the page fault handler comprises:
sending a memory access for the compressed page to the memory buffer device;
responsive to the request, reading the compressed page from the memory buffer device; and
performing decompression of the compressed page to a local memory of the host device.

17. The method of claim 15, wherein executing the page fault handler comprises:
sending a request for the memory buffer device to decompress the compressed page to a decompressed page; and
following decompression, reading the decompressed page from the memory buffer device.

18. The method of claim 14, wherein obtaining the compression context metadata comprises obtaining a pointer to the compressed page.

19. The method of claim 14, wherein obtaining the compression context metadata comprises obtaining a pointer to the compressed page and one or more decompression parameters for decompressing the compressed page.

20. The method of claim 14, wherein the memory buffer device is integrated in a serial-attached memory module and wherein the host device communicates with the memory buffer device over a serial communication link.
